(19) United States
(12) Patent Application Publication
(10) Pub. No.: US 2001/0001856 A1
(43) Pub. Date: May 24, 2001

(54) Prepaid cash equivalent card and system

(76) Inventors: David B. Gould, New York, NY (US); Michael F. Rakosi, New York, NY (US)

Correspondence Address: Greenberg Traurig, LLP, 200 Park Avenue, New York, NY, 10166, US

(21) Appl. No.: 09/765,244

(22) Filed: Jan. 18, 2001

Related U.S. Application Data
(63) Continuation of application No. 09/428,310, filed on Oct. 28, 1999.

(51) Int. Cl. G06F 17/60

(52) U.S. Cl. 705/39

(57) ABSTRACT

A cash-equivalent card-based purchasing system and its method of operation, in which an information processing computer has a plurality of records stored in an associated storage device, each record including a unique cash-equivalent card number linked to a card value. A cash-equivalent card is provided to a user, the cash-equivalent card having encoded thereon one of the cash-equivalent card numbers stored in the storage device, the cash-equivalent card provided in exchange for consideration equivalent to at least the value linked to the cash-equivalent card number encoded thereon. Neither the cash-equivalent card nor the storage device has any information regarding the identity of the user.

### BACKGROUND OF THE INVENTION

The present invention relates to financial instruments in the form of prepaid cards where an anonymous user may acquire a cash equivalent card for subsequent use toward the purchase of goods and services from merchants.

A variety of financial instruments are used in commerce to provide payment in exchange for goods or services. While each of these financial instruments generally allow an individual to purchase an item, each have different levels of convenience, visibility, anonymity, and acceptability by merchants associated with their use. Currency, for example in the form of paper and coins, allows a purchaser to effectively remain anonymous. Currency is accepted by local merchants in a particular country and is exchanged for the product to be purchased where other paper or coins are returned to the purchaser in the form of change. This type of transaction is highly visible to people in the area of the transaction as the change is counted out, and placed into a suitable carrier. It is also not directly negotiable in other countries where the money must be exchanged prior to making a purchase. Other paper based financial instruments such as traveler's checks and money orders are like cash in that they are exchanged for other forms of currency when making a purchase, but may not be as negotiable due to limited acceptance. Gift certificates, generally in predetermined increments of value, are accepted as cash, but only in exchange for goods and services at a specific merchant. Gift certificates are rarely redeemable for cash and the terms of use, exchange and redemption can be set by each individual merchant issuer with little, if any, consistency.

Financial instruments such as credit cards and debit cards do not provide any degree of anonymity since they require that the user wishing to purchase an item have a named account associated with the card. While these cards have less acceptability than cash within a particular country, they are useable internationally, based on interbank or associative arrangements among participating entities regarding acceptance of a common brand or identifier. Credit card purchases do not instantly transfer funds but instead create a receivable and a record of a transaction that the purchaser must pay later when billed by the card issuer. Credit cards allow purchases (i.e., creation of receivables) up to a specified credit limit based on an individual account relationship and determination of individual creditworthiness. Debit cards, like credit cards, are linked to a specific account of an individual at the financial institution, but transfer funds from the owner's account to the merchants account. An authorization routine is typically employed where the financial institution is contacted during the purchase to verify that the account is valid and that it has sufficient funds.

Prepaid cards are not typically associated with a financial institution, but are more likely associated with the use of a particular type of service available from a merchant based company or a utility service. Long distance phone services sell prepaid cards, where an amount of money is paid in advance of use in exchange for time or accessibility to a service. Gift certificates similarly reflect prepaid amounts, which may be used at the particular merchant or retailer issuing the certificate. Prepaid cards that are sold by someone other than the actual issuer typically require the seller to pay for the card in advance of the consumer's ultimate purchase or at the point of sale when the card is activated.

A different type of card is the prepaid or secured credit card. This is a limited value card where a named user is historically a poor credit risk and therefore must prepay some amount of money to a financial institution. This security money is used to safeguard the financial institution in case the user does not pay for the items purchased. Although technically not a debit card, the prepaid amounts function as a guarantee by purchaser and can be drawn against in the event the funds advanced under the credit card account are not paid.

Each of the aforementioned financial instruments has some limitations that make them unsuitable for use in certain situations. For example, parents have given credit cards to their children for expenses incurred while away from home at school, but this creates a risk that the child may charge excessive amounts to the card during a billing period. It is also unlikely that the student would be able to acquire a credit card in their name alone, this might result in a parent establishing a joint account with the student for a credit card. All purchases made by the student are now liabilities of the parent. This is an undesirable situation for the parent. If the child is able to get a credit card in their name alone; the child may not use sound judgment in their card use and may in a short period of time create an insurmountable or difficult debt burden for themselves, adversely affecting possibly both their own and their parent's credit rating. Money or cash, while limiting the risk of indebtedness, does not provide any degree of accountability or traceability and also may need to be exchanged if the student is located in another country. Money is also subject to theft, generally with no ability for the average individual to trace or stop further use and with little recourse or likelihood of recovery. Other paper based monetary equivalents may be converted into cash.

In virtually all cultures in the modern day, general purpose, widely accepted credit cards have become an extremely desired and often required mechanism for conducting transactions, not merely as a status symbol, but also to facilitate both personal and commercial transactions. Many people utilize cash for purchases, but would rather use a credit card or other, more secure type of device. In fact, the proliferation of catalog, direct mail and telephone sales, as well as sales of goods and services over the Internet, has become a multi-billion dollar business—all beyond the reach of anyone without a card or other generally accepted instrument that can initiate a purchase transaction through an automated electronic information processing system. Often, these individuals are unable to obtain a credit card since they do not have ready access to a bank or may have difficulty in qualifying for a line of credit perceived as profitable for many financial institutions.

What is desired therefore is a cash equivalent card and system where the purchaser does not require the formalities of an account or the rigors of credit checks and where the right to activate such a card is transferred to the user at the point of sale or where a pre-activated card is given to the purchaser in exchange for payment. The card is identifiable, but is not associated with a named user and is readily used and transferable. The card retains an associated residual value following use based on remaining balances of prepaid amounts, where the residual value is stored in a computer associated with the system. The card usage may be recorded and tracked on a system to provide traceability of use. What is also desired is a way for the card to be partially activated at the point of sale and prior to use, such that the card may be transferred to a location where it is to be used and is then completely enabled for use. It is also desired that a controlling user may be established for the card to review and/or control the transactions via an interface to the system, for example over the Internet.

Importantly, it is desired that the prepaid cash-equivalent card be accepted by merchants that already accept credit cards such as MasterCard or VISA.

### SUMMARY OF THE INVENTION

The present invention is a cash-equivalent card-based purchasing system and its method of operation. In this system, an information processing computer has a plurality of records stored in an associated storage device, each record including a unique cash-equivalent card number linked to a card value. A cash-equivalent card is provided to a user, the cash-equivalent card having encoded thereon one of the cash-equivalent card numbers stored in the storage device, the cash-equivalent card provided in exchange for consideration equivalent to at least the value linked to the cash-equivalent card number encoded thereon. Neither the cash-equivalent card nor the storage device has any information regarding the identity of the user.

The user activates the cash-equivalent card for subsequent use such that a purchase transaction may be executed with a merchant for a purchase item having a corresponding purchase amount. In the purchase transaction, the user presents the cash-equivalent card to the merchant. The merchant, utilizing a purchase authorization system associated with a generally accepted credit card, requests authorization from the information-processing computer that the purchase transaction amount is not greater than the remaining card value stored in the storage device. The information-processing computer then reduces the value stored in the storage device by the purchase transaction amount if the authorization is successful and the transaction is consummated.

The activation of the cash-equivalent card may occur in various ways. In one aspect, activation data is programmed in a record in the storage device that is associated with the cash-equivalent card provided to the user. Activation may occur by altering a characteristic of data already encoded on the cash-equivalent card. Activation may occur at substantially the same time that the cash-equivalent card is provided to the user, or it may occur during a card distribution phase substantially prior to the time that the cash-equivalent card is provided to the user.

Activation may occur by storing an activation string in a record in the storage device that is associated with the cash-equivalent card provided to the user, then providing the activation string to the user, and then activating the subsequent use of the cash-equivalent card only after the activation string has been subsequently communicated to the information-processing computer. The activation string may be subsequently communicated to the information-processing computer via a telephone-based data entry system or an information-processing-based data entry system such as devices connected to the Internet.

The present invention also provides for variation of the value stored in the storage device in accordance with a predetermined function. For example, the predetermined function may be an increase (or a decrease) of the value as a function of time. The predetermined function may be an increase of the value in a random manner. The predetermined function may be related to the frequency that the cash-equivalent card is used for making a purchase, or it may be related to the number of purchases made within a predetermined (or randomly determined) period of time.

Regarding the cash-equivalent card, the cash-equivalent card number may be encoded in a number of ways, including, without limitation, a magnetic stripe on the card, it may be encoded in a bar code symbol printed on the card, or it may be encoded in an RF-ID transponder associated with the card.

The value may be denominated in a base currency type and the purchase amount in a purchase currency type, and if the purchase currency type is different from the base currency type, then the execution of a purchase transaction would comprise converting the purchase amount to a converted purchase amount denominated in the base currency type. The value stored in the storage device may be reduced by a transaction, foreign exchange or other fee related to the purchase transaction.

Each cash-equivalent card may have associated in the storage device a record of previously executed purchase transactions. Each record of a previously executed purchase transaction may identify the types of goods and services previously purchased with the cash-equivalent card, and/or identify the merchant with whom the purchase transactions have been consummated. Similarly, each cash-equivalent card may have associated in the storage device an allowable purchase item type record comprising a listing of allowable purchase item types, wherein the purchase authorization comprises transmitting to the information processing computer an identification of the purchase item, determining if the purchase item is listed as an allowable purchase item type, and disallowing the transaction if the purchase item is not listed as an allowable purchase item type. Likewise, each cash-equivalent card may have associated in the storage device a disallowable purchase item type record comprising a listing of disallowable purchase item types, wherein the purchase authorization comprises transmitting to the information processing computer an identification of the purchase item, determining if the purchase item is listed as a disallowable purchase item type, and allowing the transaction if the purchase item is not listed as an allowable purchase item type.

Each allowable purchase item type record may further comprise an associated budget amount or monetary limiting amount; the purchase authorization would then further comprise the steps of allowing the purchase transaction only if the purchase amount is not greater than the budget or limiting amount associated with the purchase item, and then reducing the budget amount associated with the purchase item by the purchase amount if the transaction is allowed. The budget or limiting amount associated with each allowable purchase item type may be controllable directly by an authorized user provided with access to the budget amounts via a user computer in selective communication with the information-processing computer or indirectly through communication by the authorized user to the controller of the information-processing computer.

### BRIEF DESCRIPTION OF THE DRAWING

FIG. 1 is a block diagram of the cash equivalent card and system of the present invention;

FIG. 2 is an illustration of the cash equivalent card of the present invention;

FIG. 3 is a data flow diagram of the card activation process of the present invention;

FIG. 4 is a data flow diagram of the card transaction process of the present invention;

FIG. 5 is a representation of an administration interface to the cash equivalent server of the present invention;

FIG. 6 illustrates various distribution and activation processes; and

FIG. 7 is a diagram of a typical data record associated with the cash equivalent card.

### DETAILED DESCRIPTION OF THE PREFERRED EMBODIMENT

The cash-equivalent card-based system and method of the present invention provides the ability for a consumer to purchase the card of the present invention to allow anonymous users of the cards to make subsequent purchases at any merchant location compatible with the cash equivalent system, in particular a merchant that already accepts credit cards and debit cards for payment.

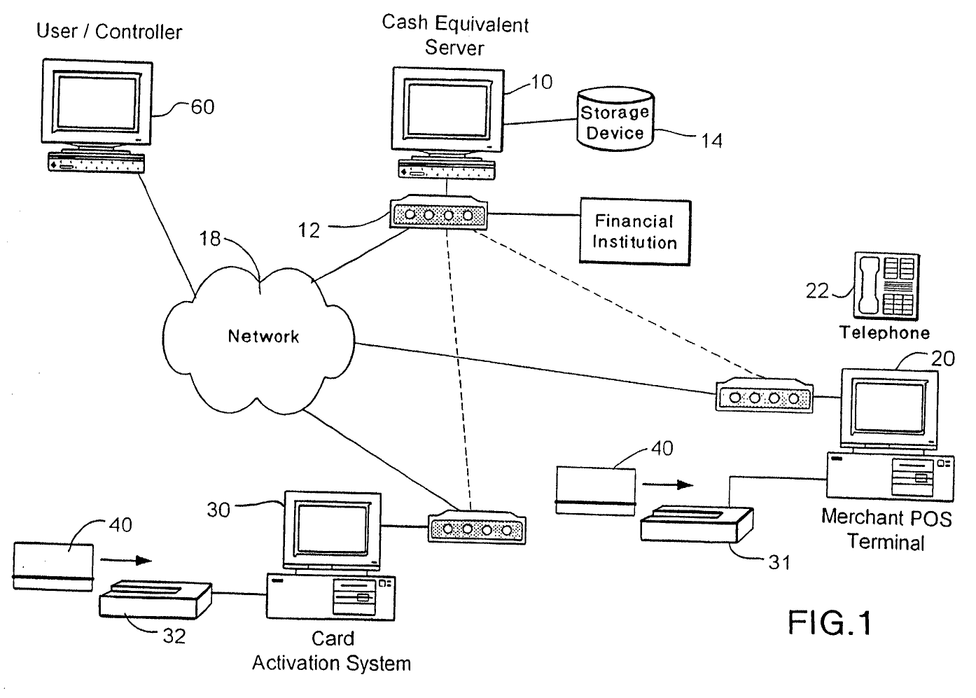

The system shown in FIG. 1 comprises an information processing computer 10, also referred to herein as a cash equivalent server connected through a communications network 18 such as the Internet to a plurality of purchase authorization devices 31 located at associated merchant POS stations 20, wherein a cardholder may use a cash equivalent card 40 in cooperation with the purchase authorization devices 31 to execute transactions with the cash equivalent server 10 which cause a corresponding value on the cash equivalent server to be reduced by a purchase amount.

In the preferred embodiment, the cash equivalent server 10 comprises information processing means, a storage device 14 and a connection device 12. The connection device 12 allows the purchase authorization devices 31 such as a card reader 24 to connect to the cash equivalent server 10 to perform the interactive processes of card activation, authorization, financial transaction processing, and marketing information collection. The server 10 interprets and processes the requests received via the connection device 12. The storage device 14 stores data related to the processes performed and preferably comprises a database to hold information about cards and the executed transactions. The database may additionally be used to store merchant information that can be used for tracking card usage and activation locations. The cash equivalent server 10 of the present invention may be linked to a financial institution such as a bank or may be associated with any commercial institution permitted to manage a value associated with a card account. For example, credit card companies could utilize the cash equivalent server 10 of the present invention to allow anonymous purchasers of the cash equivalent cards to maintain a cash balance associated with the cash equivalent card. The connection device 12 may comprise tone-based communications using a telephone-devices and modems or may comprise other forms of wired or wireless communications such that the merchant may contact the cash equivalent server 10 in some manner to perform the transactions required to verify or update the cash equivalent card balance 10 associated with the card.

In the preferred embodiment, the merchant equipment may be a point of sale terminal device 20 and a card reading device 31 (in the case of the POS/authorization system) or an activation device 30 and card activation device 32 (in the case of the card activation system) connected to the network such that the merchant devices can communicate with the cash equivalent server 12 in a manner similar to the way credit card systems are implemented. The card reader 31, 32 may be any type of card reader such as a magnetic stripe reader, RF-ID transponder reader, or a bar code scanner that can interpret the data printed on or stored in media associated with the cash equivalent card 40.

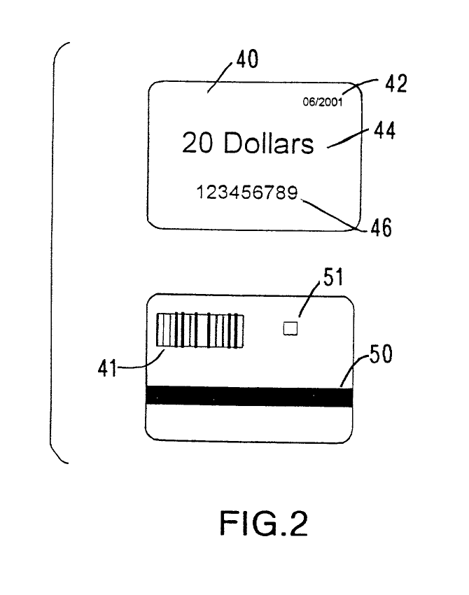

The card data contained on the cash equivalent card 40 (see FIG. 2) may be in the form of visible indicia such as a bar code 41, or it may be a magnetic stripe 50 such as what is typically found on a credit card, where the card number 46 is applied to or identified upon a card. The cash equivalent card 40 may be made from plastic or some other durable yet flexible material where the card thickness is compatible with existing card reading devices.

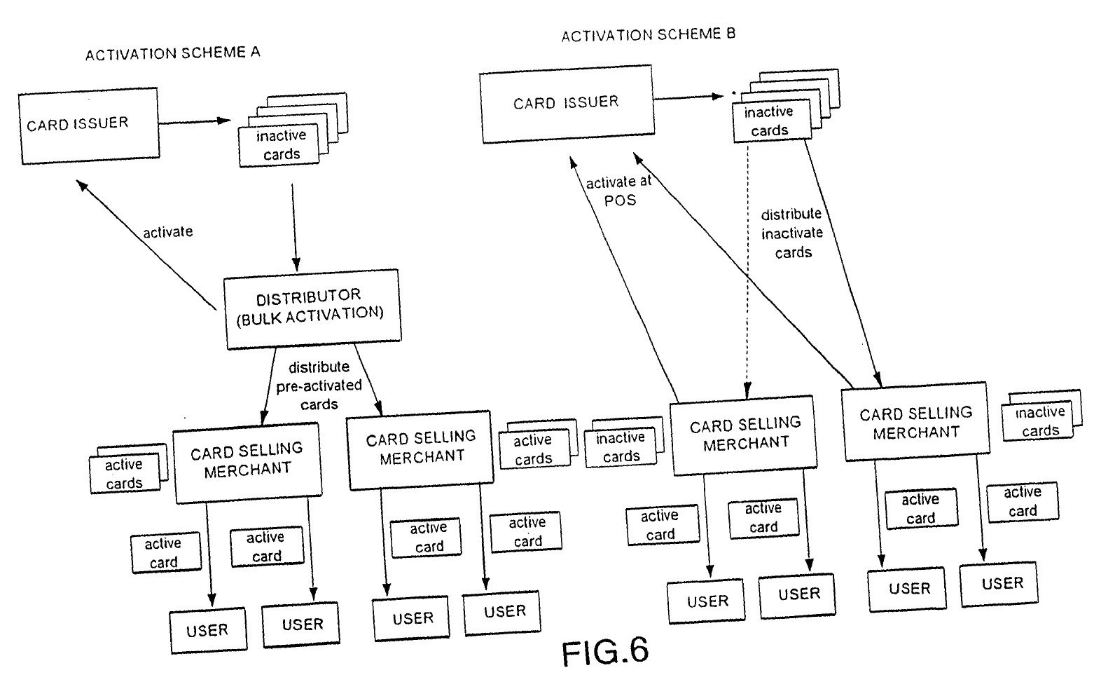

Referring to FIG. 6, the cash equivalent card 40 may be pre-activated by a card distributor 100 prior to placement with a card-selling merchant 102 such that it is ready for subsequent use at the point of purchase. In the preferred embodiment, the cash equivalent card 40 will be provided directly to a card selling and activating merchant 104 (or via a distributor that does not activate the card but merely resells it), and this will require activation by the merchant 104 prior to use. The cash equivalent card may have an associated value pre-assigned to the card, such as $10, $20, $50, $100, $500 or $1000, or the card may be capable of having the value assigned by the merchant 104 at the point of purchase and activation. The pre-assigned value 44 may be displayed on the card as shown in FIG. 2. The card may optionally be assigned an expiration date 42.

These cards 40 are cash equivalent cards meaning that they may be used anywhere that a merchant will accept the card 40 toward payment of any good or service sold. Since the cash equivalent card 40 is preferably inactivated prior to sale as shown in part B of FIG. 6, the merchant may place these inactivated cash equivalent cards 40 on a shelf or at an unsecured location in their store. In the manner shown in part A of FIG. 6, already activated cash equivalent cards 40 may be used with this system where the cards must be stored in a secured area to prevent theft. In another embodiment, the card can be assigned a value at the point of purchase, by contacting the cash equivalent server 10 and setting the account balance corresponding to the card at the value specified.

The cash equivalent card 40 works with the cash equivalent server system of the present invention to provide a means for paying for items using predefined and prepaid value, without need to establish or maintain an account or obtain credit. Prior art general use cards require the card to have a user name associated with a card or other individual account in the name of the user or store the value within the card itself. The cash equivalent card 40, in contrast, does not require a name or any user's name to be associated with the card, but still provides the security of an activation, authorization and modern communication system. The user purchases the cash equivalent card 40 using any means of payment available to the user that is acceptable by the merchant offering the card for sale. For example, a user that pays for a cash equivalent card 40 in cash may then use the card anywhere that the card is accepted without identifying himself to the merchant using other forms of identification. If however, when payment means such as a check, credit card or debit card are used to purchase a cash equivalent card 40, the cardholder's name while known during the transaction is not associated with the actual cash equivalent card 40 account on the cash equivalent server 10. In such cases, the purchase of the card will ultimately be documented on the purchaser's checking account or credit card statement, but no record is made of the actual account number for the cash equivalent card 40 purchased. These cards therefore, may be treated as a direct cash-equivalent.

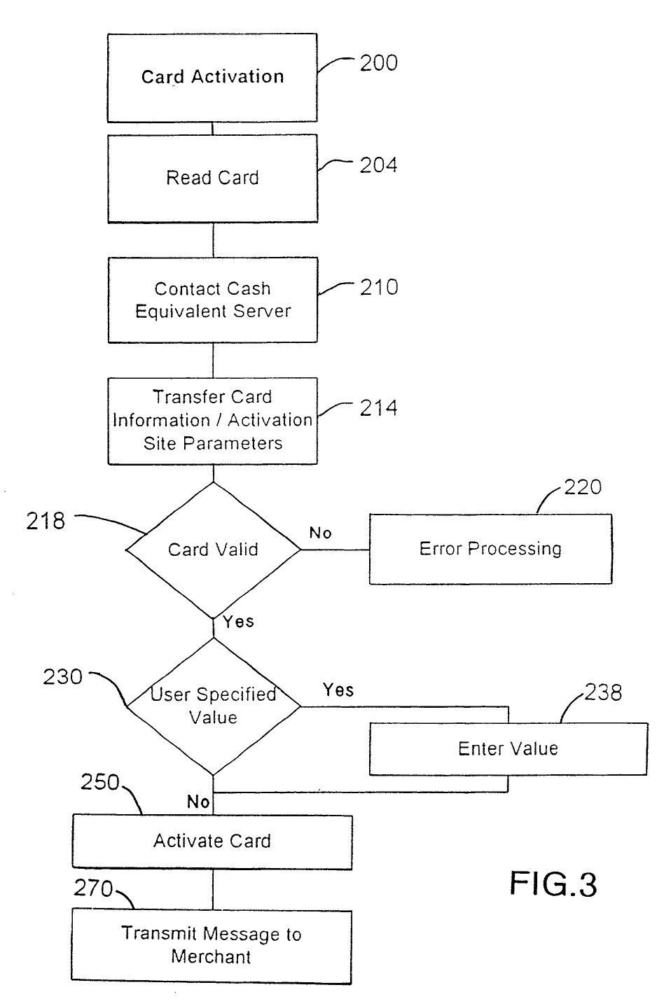

With regard to FIG. 3, during the activation process 200 the card is read by the activation device 32 at step 204. The indicia on the card is read to determine how to contact the cash equivalent server 10 or the activation system 30 is preprogrammed to dial the proper number of the server 10. The connection device 34 of the merchant system 30 contacts the cash equivalent server 10 at step 210. The cash equivalent card number 46 is sent to the server 10 at step 214, and is the only link to the associated value maintained in storage of the cash equivalent server 10. A database may be used to track the cash equivalent cards delivered to each merchant. Verification may optionally be provided at step 218 at the point of sale and activation to assure that the card is being activated by the merchant that originally purchased the cards. In this manner, theft of the cards and attempted activation at a different location may be prevented or trigger added authorization measures or may cause the cards to become invalid. Additionally, some form of traceability may be provided for the cards to allow marketers to determine where the cards are purchased and when the cards are used at merchant facilities.

The preassigned value of the card is determined from scanning the stripe 50 or bar code 41 and is optionally transmitted to the server 10 along with the card number 46. The owner of the establishment desiring to sell the cards to users (i.e. the card selling merchant) is required to pay the server 10 of the present invention or an agent of the cash equivalent server 10 all or a portion of the money received from the purchaser. This payment process is managed using prior art methods as known to those skilled in the art. In addition, at the point of purchase, the user will be provided a phone number, Internet address or other contact information to enable the verification of the remaining available balance (i.e., the value) corresponding to the card, at any time.

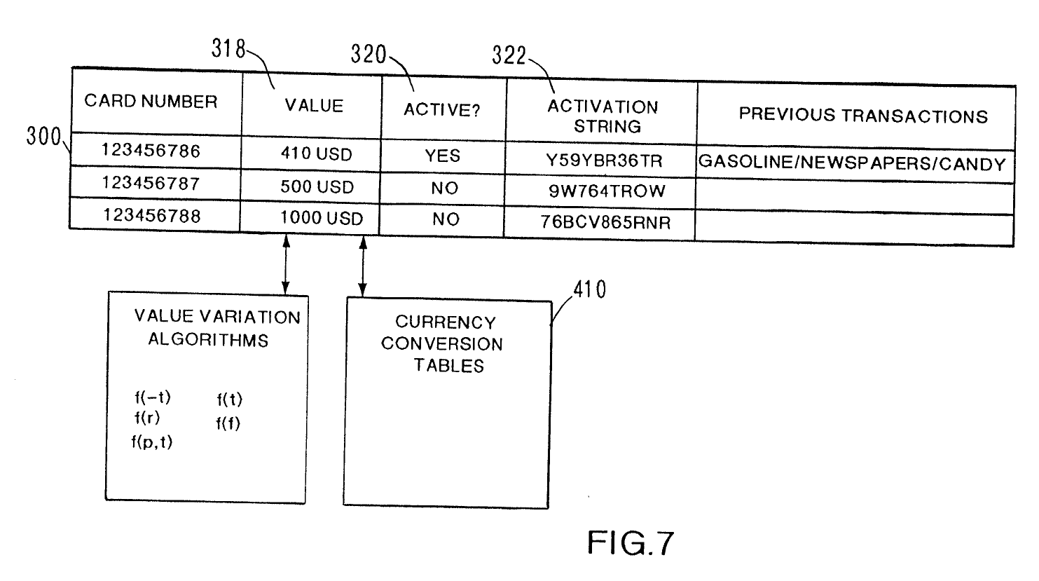

If the user has selected a card without a predefined value (i.e. one that can be assigned a value at the point of sale) (step 230), then the merchant provides enters the value that the card is to be assigned at step 238. The cash equivalent server verifies that the information received (card number, amount) is correct by checking the database records in storage device 14, and activates the card at step 250 accordingly. Activation may be as simple as setting a flag 320 (see FIG. 7) so that subsequent uses of the card to purchase goods and services are enabled. Finally, a message is sent to the merchant at step 270 to indicate a successful activation.

As with general-purpose credit cards, the cash equivalent cards additionally may be used across country and currency boundaries, where the cardholder could purchase the card in one country and then travel to another country to make a purchase. For example, a cash equivalent card purchased in Mexico may be paid for in pesos and then used in the United States to buy an item. During the transaction, the system would allow the user to pay for the item in the currency of the country at the merchant location. Referring to FIG. 7, a direct exchange calculation is made using an exchange rate calculation process 410. The exchange rate process may be part of the cash equivalent server process or may be a process that is supported by a trusted third party or designated financial intermediary. Following conversion of the cost of the item, the value 318 is checked to assure that the remaining funds associated with that card are sufficient to pay for the item. The value is then modified to reflect the transaction amounts, and notification is sent to the merchant device approving the transaction.

In another embodiment, a local country code number may be embedded to automatically cause the dialer associated with the point of sale system or scan device to contact a local calling number to contact a mirror site of the cash equivalent server. The mirror site may reflect the associated balance to a card in the currency of that country. A synchronization process may be used to have the cash equivalent servers communicated with each other to coordinate the balance.

In another embodiment, a phone-based method may be used to purchase items where the cash equivalent server is contacted by telephone 22 (see FIG. 1) in order to modify the value 318 associated with a cash equivalent card of the present invention. The merchant from a phone may call the cash equivalent server using a provided phone number. The merchant may be instructed via a voice response system to indicate the account number and the purchase amount. A separate scanner may be required in case the account number is not directly viewable or discernable by the merchant. The card may optionally have magnetic, optical, digital or other encoding or an embedded chip or other information storage means to generate signals indicative of the card and merchant indicia.

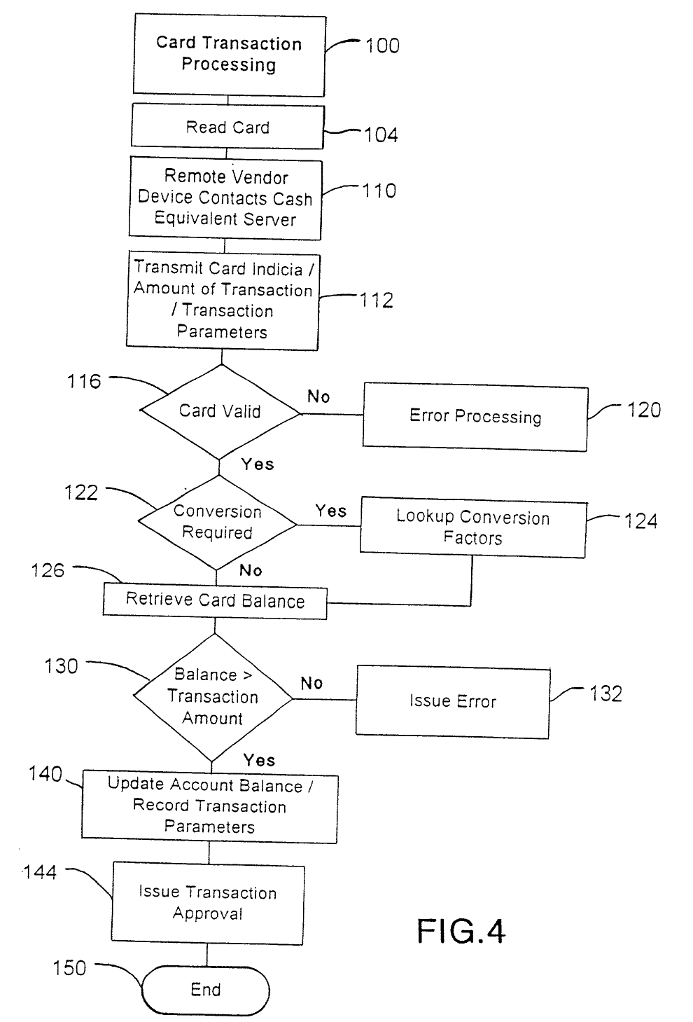

The process carried out when a consumer uses his cash-equivalent card to purchase goods or services from a merchant who normally accepts credit cards will now be described with regard to FIG. 4. The card 40 is read in a manner as similarly described during the activation process where the merchant uses the card reader 31 in coordination with a point of sale device 20. The card number that is to be linked to the associated card value 318 on the cash equivalent server 10 is read by the card reader 31 at step 104. Identification data of the card (such as the place of issue) may also be read in addition to parameters of the merchant (i.e. bank accounts, addresses, exchange rate) and the amount of the transaction for the current purchase. The merchant equipment contacts the server at step 110, and the relevant information is transmitted to the cash equivalent server 10 at step 112. The card is checked at the server 10 to ensure that it has been activated at step 116. This process will check the activation flag 320 associated with the card number 46. If the card is not valid, error processing routines and verification steps (step 120) may be implemented by the cash equivalent server 10, such as comparing a voice data sample of the purchasing user that requested the card to be activated or by some other known indicia that was entered by the cardholder such as a PIN.

In response to the information received from the merchant, the server 10 looks up parameters of the merchant if available and/or looks up other data that may be used in coordination with the information received from the merchant device at step 122 in order to determine if a currency conversion processes may be required. For example, if the country or currency or language of the device indicates that conversion is required, then the corresponding conversion factors (such as the appropriate currency exchange rate) are looked up at step 124. The current value (i.e. balance) of the cash equivalent card is then retrieved from the storage device at step 126. The cash equivalent server may either keep balances for individual users in a base unit of measure or currency or a local currency to where the card was activated. The user may optionally define the currency at the point of activation by choosing the currency where the card is to be utilized. If the exchange rate is different from the base currency used in the cash equivalent server system, the exchange rate conversion process is performed that retrieves from memory 410 of the cash equivalent server (or from an alternate location) the exchange rate to be used with the transaction. The appropriate conversion rate is selected and the processor converts the value of the item or service to be purchased.

At step 130 the current value of the card available balance is compared to the requested transaction amount to verify that the purchase may be consummated. If insufficient value is available for the card, an error is issued at step 132. The error processing step may allow the user to cancel the transaction, or the user may be requested to make up the difference in the cost of the item using another payment means such as actual cash. If the comparison indicates that the value linked to the card is enough to cover the cost of the transaction (including any transaction fee or conversion fees if applicable), then the value is then decreased at step 140 to the appropriate amount. Other data from the parameters received from the merchant about the transaction may be logged at this point to record the historical point of sale information related to the cash equivalent card. This information is preferably stored as a time-stamped and/or merchant identified record in the database that may be used to track the transactions that were recorded for that cash equivalent card. The cash equivalent server then transmits back to the merchant device the approval of the transaction at step 144.

Preferably the card and system of the present invention may be used as an extension of a generally available credit card brand utility. Such a company typically has the facility to authorize and record purchases as part of the point of sale functionality already supported. This card, while not having a name or identity associated with it, will allow cardholders to have the transaction authorized in the manner of a credit card without awkward processing steps or requesting personal identification such as is required when purchases are made by personal check.

In the preferred embodiment, the card balance is accessible for debits only, where the purchases eventually deplete the card balance or leave a small residual value that will not be redeemable toward a purchase. There may be a refund fee associated with the transaction that is either set by the merchant or by the cash equivalent service. In the preferred embodiment, refunds of the residual value may be not permitted. The cardholder would then have a card with little residual value that may be unredeemable. The system may charge a fee for carrying balances with small residual value. For example, any card with a purchase price under fifty dollars that has a residual value less than 10 percent of the original purchase price might be charged a fee to keep the card balance active on the system. This would have the effect of reducing the value associated with the cash equivalent card to zero within a specified time period.

A transaction cost or fee may be assessed by the system to the cardholder account whenever the card is used. This fee may be applied to support the operation of the cash equivalent server, support personnel, or infrastructure requirements. The fee may additionally be paid to the merchant that allows the card to be used. In another embodiment, the card may cost more than the face value of the card. For example, a cash equivalent card that has a net value of fifty dollars may cost the purchaser fifty-five dollars. The five dollar difference would offset the system operating expenses and a portion of that fee would be directed to the merchant selling the card.

The actual transfer of funds between the cash equivalent service and the merchants preferably uses automated and/or manual payment methods known to those skilled in the art, where the cash equivalent server is credited or debited according to the transactions recorded and authorized by the system.

The cash equivalent card of at least one embodiment allows the cardholder to enter a PIN or other unique identifier at activation that may be checked during subsequent purchases to limit the use of the cash equivalent card to those that know the proper PIN. The authorization process may inactivate the card following a predefined number of unsuccessful attempts to use the card. Since the card has no name association but can be uniquely identified in the system, loss of the card may result in loss of access to the funds associated with the card, however, the user may still be able to link a new cash equivalent card to the remaining value associated with a lost or stolen card if they provide suitable proof of the ownership or original purchase.

The message transmitted to the cash equivalent server provides information about the merchant sufficient to enable the payment for the items purchased by a cardholder. The merchant information may comprise bank account information for the merchant such as where payment should be directed and may define the location where the purchase was made. The message may additionally provide information regarding the product(s) purchased by the cardholder. Valuable marketing information may be compiled by analyzing this product information to determine where, when and how the cash equivalent cards are used by the cardholders. Strategies for supplying new types of cash equivalent cards for the consumer market that are compatible with this system may be derived, and the marketing information may additionally be used to identify the types of products or services purchased with these cards. For example, users of these cards may purchase products that they would not typically purchase on a credit card or debit card or where using cash is not convenient.

Parents might use the cash equivalent cards to provide emergency or predefined funds to children. Businesses might use the cash equivalent cards as travel or purchase cards for employees who might otherwise require large amounts of cash. Celebrities and other famous people might use the cash equivalent cards of the present invention at hotels where they would desire to remain anonymous without carrying around large sums of cash. The cash equivalent card, while allowing marketers to determine card spending patterns, avoids privacy problems associated with traditional card or other devices. In addition, the cards allow the cardholder to make purchases internationally where the exchange rate is immediately determined and the residual value of the card is immediately known to the cardholder and not subject to fluctuations in the exchange rate that may occur between the purchase, posting, billing and payment time.

The functionality of this cash equivalent card is also important to cardholders that are on a budget, or have been allocated a limited amount of money through the card. A parent may give a cash equivalent card to a student to be used for general purchases for a period of time. For example, a parent gives a student a cash equivalent card worth 200 dollars and expresses that this is to last the student a month.

In the preferred embodiment, a network interface is established such as via a telephone or the Internet to allow the cardholder or another that knows the card number to view or review purchases made using the card. An Internet accessible form may be used to allow the parent to enter the card number to query the transaction history for purchases made using the card. In this manner, the parent may remotely view the student's purchases on their computing device 60 to determine how well the student allocates the funding provided. In contrast to a credit card in the name of the student and the parent, the liability of this card is limited to the card amount purchased. When the cards value is exhausted, no further purchases may be made. This enables the student to learn how to properly budget their expenditures without risking their or their parent's credit rating. The cash equivalent server may additionally verify that the merchant is a valid merchant device able to connect to the server by initially checking a database of the data received from the card and comparing the data received to a database of valid or invalid merchant data. The system could additionally flag the system operators to an invalid attempt to have an illegitimate site request and receive payment for one or more items that were never actually purchased by tracking and analyzing suspicious merchant activity. This activity may be identified by reviewing the source location or comparing prior purchasing records to newly received transaction requests. These transactions may cause the account to be placed in a hold condition until the cardholder contacts the cash equivalent server or a representative thereof.

In another activation method the card may be purchased in one location as an inactive card or where the activation process enables the card to be provisionally or partially activated. The card may then be transported to a destination where it is fully activated for use. Alternatively, the cash equivalent card may be sent to a second party either locally or internationally via mail or courier, where the card is fully activated upon reaching the destination user. The destination user may then activate the card by communication with the cash equivalent server and entering a required card activation string, such as a pre-assigned password. The communication may be made through an Internet enabled device, a local point of sale terminal or via telephone where the user or designated merchant establishment enters the activation string to complete the activation process. . The card will not be usable though until the activation process is completed. The second step of the activation process that is carried out at the destination will update the record again to indicate that the card has been fully enabled for use.

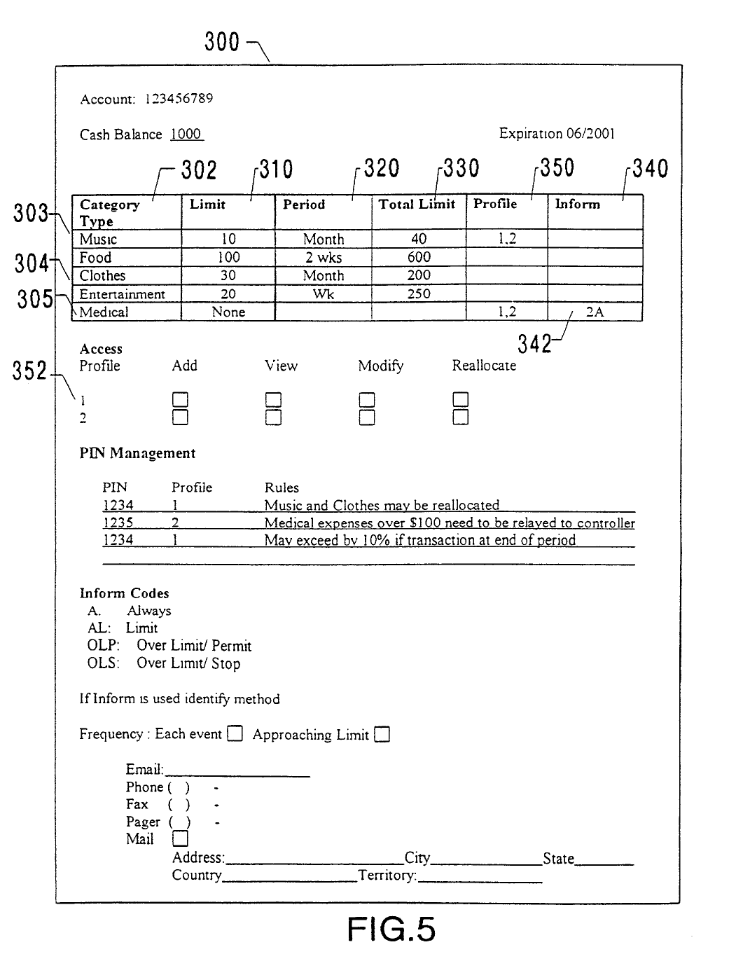

The cash equivalent card and system of the present invention may provide other functionalities to the participants in the authorization process. At the point of purchase, the cash equivalent card may have control parameters that may be employed to temporarily enable or disable the ability of the card to be used by the cardholder. With regard to a prior example of a parent and a student at a remote university location, the parent (controller) of the student (target cardholder) may be able to use control codes known only to the parent to place a hold on the use of the card by contacting the cash equivalent card server via a telephone call (or pager message, Internet instruction, satellite channel, or wireless device) where an automated or manual system interface is provided to either activate or inactivate the card based on the instructions received. The Internet-based interface 300 for example (see FIG. 5), may provide even more sophisticated control of the usage of the card. The controller may use the provided access codes to limit periods of use to weekends only or to allow the card to be used only in certain geographic regions. Alternatively the controller may establish budget-type rules on the server to allow the cash equivalent server to limit expenditures within defined intervals of time to not exceed to a controller-defined value. The controller may additionally restrict the types of merchants that may be permitted to receive payment from the system. The controller may enter an administrative sequence that would allow the controller to enter merchant types with corresponding spending limits that may be purchased using this card for a particular time period. For example, with regard to FIG. 5, the controller may specify in a tabular or list form, the category or type of allowable purchase type 302, the budget amount 310, the budget period 320 for that budget amount, a total expenditure 330 for that category and a request field 340 such that the controller is informed whenever a expenditure is made in the corresponding row, which may be additionally based on the level of expenditure. In the example interface shown in FIG. 5, the destination user (student) is limited to 10 dollars (312) a month (322) up to a maximum of 40 dollars (332) for music purchases. Food, clothing and entertainment (304) have similar values limiting the manner in which the card may be used. The medical category (305) does not specify any limiting parameters but does request that the controller is informed (342) of any expenditure made. Any type of notification may be made to the controller by the system such as via electronic mail, pager notification, etc. The integration of this functionality with the output from the point of sale equipment and other types of charge capable devices allows detailed review of all transactions by the controller. The destination user may be restricted geographically or to buy from the categories entered, or alternatively other categories left unspecified may have either no limits or default limits. For example a percentage of the total available balance may be applied to a miscellaneous category until the cash equivalent card balance is depleted.

This same functionality may be used to manage office expenditures where the planned expenditures may be planned into the system and where expenses incurred can be monitored in real time. The card balance ultimately controls the point at which the system halts all further expenditures using that card. The system could inform the controller in anticipation of the depletion such that a new account may be specified. In the preferred embodiment, the depleted account may be used as a prototype that can be copied for a new cash equivalent card for a limited amount of time before the code administrative function is disabled for that cash equivalent card account on the cash equivalent server. This control functionality may be additionally be used by existing credit card companies to allow credit card customers to allow customers to manage personal, family, and business spending throughout the year where the billing periods defined may correspond to either calendar periods, billing periods, or pay periods as the user defines them to effectively control a budget at the point of sale.

The destination user may be given access to the administrative form to review the inputs made by the controller. The user may place further restrictions on their own spending to decrease the available limit for a particular category. This type of modification may permit the user to reallocate potential savings into other categories if permitted by the controller. Access and control may be shared by selecting check boxes on the interface. Other limits may be specified using rules to implement either notification of events or to limit spending or to reallocate spending. For example the controller create multiple PINs 360 that may be used during the point of sale transaction to cause different rules to be enforced. The access profile parameter 350 may give the PIN 360 different levels of authorization to change or modify values in the table. The destination user would not see this screen but would instead be able to access a different form where the user would only see or be able to control those items that correspond to the account and PIN that have been granted either view, modify, or reallocate privileges. These are sample control fields to demonstrate the functionality of the system, other controls and access capabilities may be implemented to extend the functions to include geographic restrictions, time of day or other restrictions.

It is also a function of this invention that different users may use the control system of this invention where at the point of sale a code or PIN may be entered to allow the user to have access to different purchasing options. For example, the controller of the card may be able to allocate different purchasing options to different users of one credit card or cash equivalent card. The user may be required to enter a PIN at the point of sale to access higher levels of authorized or allowed spending in different categories.

The cash equivalent cards and the control aspects of the present invention may therefore be used by payment instrument companies such as VISA, MasterCard, and American Express where the existing authorization system is expanded to provide the additional functionality described to allow the cash equivalent card and budget control process to be seamlessly used throughout the world. Indeed, one embodiment could perform these functions for travelers checks or other cash equivalent instruments which are or could be encoded with unique instrument bank routing and transit numbers or other indicia which can be verified and communicated in a variety of telephonic, electronic, digital or other communications means.

Incentives and rebates may additionally be supported in this system where the cash equivalent server may track transactions recorded related to a card to provide purchasing incentives to the user such as, to buy more of a particular product, to visit merchant locations, to purchase other products or to increase the usage of the cash equivalent card. Frequent purchases of movie tickets for example, may cause the cardholder to periodically receive free admission at a particular location upon presentation of the card. Contests or sweepstakes may additionally be offered through use of the cash equivalent card where the contest is made available by a merchant through the cash equivalent server or from an offer made by the cash equivalent server directly. The cardholder may be informed that they have won the contest or sweepstakes when the cash equivalent server is contacted from a point of sale. Rebates may optionally be redeemed at the point of sale. Incentives may also be provided by other than merchant companies via the cash equivalent server. For example, industry trade groups may provide rebates or coupon-like returns on purchases of products belonging to particular trade categories such that a purchase using the card at any one of a number of dairy related companies may be afforded an incentive at the point of purchase. The incentive is applied to the final price that was submitted to the cash equivalent server with the cardholder receiving the benefit of the lower price deducted from their cash equivalent card balance and the merchant receiving the full payment from the cash equivalent server with the trade group making up the difference. These type of incentives may be flagged based on the product type or the merchant category, where the cash equivalent server looks in memory for applicable incentives as part of a data processing step following reception at the cash equivalent server.

In another embodiment, for cards that have been purchased and not used, the cash equivalent server may provide incremental value or other incentives if the card is not used or where the card available balance is increased periodically based on specified parameters of criteria.

The system of the present invention may additionally provide points or other usage tracking means to the card based on purchases made. The points are recorded against the cash equivalent card record in the database. The cardholder may access the cash equivalent card information to review points awarded.

We claim:

1. A method for operating a cash-equivalent card-based purchasing system comprising the steps of:
a. storing in a storage device associated with an information processing computer a plurality of records, each comprising a unique cash-equivalent card number linked to a value;
b. providing to a user a cash-equivalent card, the cash-equivalent card having encoded thereon one of the cash-equivalent card numbers stored in the storage device, the cash-equivalent card provided in exchange for consideration equivalent to at least the value linked to the cash-equivalent card number encoded thereon, the cash-equivalent card comprising no information regarding the identity of the user;
c. activating the subsequent use of the cash-equivalent card provided to the user; and
d. executing with a merchant a purchase transaction for a purchase item having a corresponding purchase amount by
the user presenting the cash-equivalent card to the merchant,
the merchant, utilizing a purchase authorization system associated with a universally accepted credit-card, performing a purchase authorization step by requesting authorization from the information processing computer that the purchase amount is not greater than the value stored in the storage device, and
the information processing computer reducing the value stored in the storage device by the purchase amount if the authorization is successful;
wherein the storage device contains no information regarding the identity of the user to whom the cash-equivalent card has been provided.

2. The method of claim 1 wherein the step of activating comprises the step of programming activation data in a record in the storage device that is associated with the cash-equivalent card provided to the user.

3. The method of claim 1 wherein the step of activating comprises the step of altering a characteristic of data encoded on the cash-equivalent card.

4. The method of claim 1 wherein the step of activating occurs at substantially the same time that the cash-equivalent card is provided to the user in exchange for said consideration.

5. The method of claim 1 wherein the step of activating occurs during a card distribution phase substantially prior to the time that the cash-equivalent card is provided to the user in exchange for said consideration.

6. The method of claim 1 wherein the step of activating comprises the steps of:
i. storing an activation string in a record in the storage device that is associated with the cash-equivalent card provided to the user;
ii. providing the activation string to the user;
iii. activating the subsequent use of the cash-equivalent card only after the activation string has been subsequently communicated to the information processing computer.

7. The method of claim 6 wherein the activation string is subsequently communicated with the information processing computer via a telephone-based data entry system.

8. The method of claim 6 wherein the activation string is subsequently communicated with the information processing computer via a computer-based data entry system.

9. The method of claim 8 wherein the computer-based data entry system comprises computers interconnected over the Internet.

10. The method of claim 1 wherein a value stored in the storage device may vary in accordance with a predetermined function.

11. The method of claim 10 wherein the predetermined function is an increase of the value as a function of time.

12. The method of claim 10 wherein the predetermined function is a decrease of the value as a function of time.

13. The method of claim 10 wherein the predetermined function is an increase of the value in a random manner.

14. The method of claim 10 wherein the predetermined function is related to the frequency that the cash-equivalent card is used for making a purchase.

15. The method of claim 10 wherein the predetermined function is related to the number of purchase made within a predetermined period of time.

16. The method of claim 10 wherein the predetermined function is related to the number of purchase made within a randomly determined period of time.

17. The method of claim 1 wherein the cash-equivalent card number is encoded in a magnetic stripe on the card.

18. The method of claim 1 wherein the cash-equivalent card number is encoded in a bar code symbol printed on the card.

19. The method of claim 1 wherein the cash-equivalent card number is encoded in an RF-ID transponder associated with the card.

20. The method of claim 1 wherein the value is denominated in a base currency type and the purchase amount is denominated in a purchase currency type, and if the purchase currency type is different from the base currency type, then the step of executing a purchase transaction comprises the additional step of converting the purchase amount to a converted purchase amount denominated in the base currency type.

21. The method of claim 1 wherein the value stored in the storage device is also reduced by a transaction fee related to the purchase transaction.

22. The method of claim 1 wherein each cash-equivalent card has associated in the storage device a record of previously executed purchase transactions.

23. The method of claim 22 wherein each record of previously executed purchase transactions comprises identification of types of goods previously purchased with the cash-equivalent card.

24. The method of claim 22 wherein each record of previously executed purchase transactions comprises identification of the merchant with whom the purchase transactions have been executed.

25. The method of claim 1 wherein each cash-equivalent card has associated in the storage device an allowable purchase item type record comprising a listing of allowable purchase item types, and wherein the purchase authorization step further comprises the steps of
transmitting to the information processing computer an identification of the purchase item;
determining if the purchase item is listed as an allowable purchase item type; and
disallowing the transaction if the purchase item is not listed as an allowable purchase item type.

26. The method of claim 1 wherein each cash-equivalent card has associated in the storage device a disallowable purchase item type record comprising a listing of disallowable purchase item types, and wherein the purchase authorization step further comprises the steps of
transmitting to the information processing computer an identification of the purchase item;
determining if the purchase item is listed as a disallowable purchase item type; and
allowing the transaction if the purchase item is not listed as a disallowable purchase item type.

27. The method of claim 25 wherein each allowable purchase item type record further comprises a budget amount associated with each allowable purchase item type; and wherein the purchase authorization step further comprises the steps of:
allowing the purchase transaction only if the purchase amount is not greater than the budget amount associated with the purchase item;
reducing the budget amount associated with the purchase item by the purchase amount if the transaction is allowed.

28. The method of claim 27 wherein the budget amount associated with each allowable purchase item type is controllable by an authorized user, the authorized user being provided with access to the budget amounts via a user computer in selective communication with the information processing computer.

29. A cash-equivalent card-based purchasing system comprising:
a. an information processing computer comprising a storage device having stored thereon a plurality of records, each comprising a unique cash-equivalent card number linked to a value;
b. a plurality of cash-equivalent cards, each having encoded thereon one of the cash-equivalent card numbers stored in the storage device, each comprising no information regarding the identity of the user;
c. means for activating the subsequent use of the cash-equivalent card provided to a user; and
d. means for executing with a merchant a purchase transaction for a purchase item having a corresponding purchase amount, comprising:
an authorization system associated with a universally accepted credit-card comprising means for requesting authorization from the information processing computer that the purchase amount is not greater than the value stored in the storage device, and
wherein the information processing computer further comprises means for reducing the value stored in the storage device by the purchase amount if the authorization is successful; and
wherein the storage device contains no information regarding the identity of the user to whom the cash-equivalent card has been provided.

30. The system of claim 29 wherein the means for activating comprises activation data programmed in a record in the storage device that is associated with the cash-equivalent card provided to the user.

31. The system of claim 29 wherein the means for activating comprises means for altering a characteristic of data encoded on the cash-equivalent card.

32. The system of claim 29 wherein the means for activating comprises:
i. means for storing an activation string in a record in the storage device that is associated with the cash-equivalent card provided to the user;
ii. means for providing the activation string to the user;
iii. means for activating the subsequent use of the cash-equivalent card only after the activation string has been subsequently communicated to the information processing computer.

33. The system of claim 32 wherein the activation string is subsequently communicated with the information processing computer via a telephone-based data entry system.

34. The system of claim 32 wherein the activation string is subsequently communicated with the information processing computer via a computer-based data entry system.

35. The system of claim 8 wherein the computer-based data entry system comprises computers interconnected over the Internet.

36. The system of claim 29 wherein the information processing computer further comprises means for varying a value stored in the storage device in accordance with a predetermined function.

37. The system of claim 36 wherein the predetermined function is an increase of the value as a function of time.

38. The system of claim 36 wherein the predetermined function is a decrease of the value as a function of time.

39. The system of claim 36 wherein the predetermined function is an increase of the value in a random manner.

40. The system of claim 36 wherein the predetermined function is related to the frequency that the cash-equivalent card is used for making a purchase.

41. The system of claim 36 wherein the predetermined function is related to the number of purchase made within a predetermined period of time.

42. The system of claim 36 wherein the predetermined function is related to the number of purchase made within a randomly determined period of time.

43. The system of claim 29 wherein the cash-equivalent card number is encoded in a magnetic stripe on the card.

44. The system of claim 29 wherein the cash-equivalent card number is encoded in a bar code symbol printed on the card.

45. The system of claim 29 wherein the cash-equivalent card number is encoded in an RF-ID transponder associated with the card.

46. The system of claim 29 wherein the value is denominated in a base currency type and the purchase amount is denominated in a purchase currency type, and wherein the means for executing a purchase transaction further comprises means for converting the purchase amount to a converted purchase amount denominated in the base currency type if the purchase currency type is different from the base currency type.

47. The system of claim 29 wherein the value stored in the storage device is also reduced by a transaction fee related to the purchase transaction.

48. The system of claim 29 wherein each cash-equivalent card has associated in the storage device a record of previously executed purchase transactions.

49. The system of claim 48 wherein each record of previously executed purchase transactions comprises identification of types of goods previously purchased with the cash-equivalent card.

50. The system of claim 48 wherein each record of previously executed purchase transactions comprises identification of the merchant with whom the purchase transactions have been executed.

51. The system of claim 29 wherein each cash-equivalent card has associated in the storage device an allowable purchase item type record comprising a listing of allowable purchase item types, and wherein the means for requesting authorization further comprises means for transmitting to the information processing computer an identification of the purchase item, and wherein the information processing computer further comprises:
means for determining if the purchase item is listed as an allowable purchase item type, and
means for disallowing the transaction if the purchase item is not listed as an allowable purchase item type.

52. The system of claim 29 wherein each cash-equivalent card has associated in the storage device a disallowable purchase item type record comprising a listing of disallowable purchase item types, and wherein the means for requesting authorization further comprises means for transmitting to the information processing computer an identification of the purchase item, and wherein the information processing computer further comprises:
means for determining if the purchase item is listed as a disallowable purchase item type, and
means for allowing the transaction if the purchase item is not listed as a disallowable purchase item type.

53. The system of claim 51 wherein each allowable purchase item type record further comprises a budget amount associated with each allowable purchase item type; and wherein the information processing computer further comprises:
means for allowing the purchase transaction only if the purchase amount is not greater than the budget amount associated with the purchase item; and
means for reducing the budget amount associated with the purchase item by the purchase amount if the transaction is allowed.

54. The system of claim 53 wherein the budget amount associated with each allowable purchase item type is controllable by an authorized user, the authorized user being provided with access to the budget amounts via a user computer in selective communication with the information processing computer.
